(19) United States
(12) Patent Application Publication
(10) Pub. No.: US 2015/0044413 A1
(43) Pub. Date: Feb. 12, 2015

(54) METHOD FOR MANUFACTURING A COMPOSITE SANDWICH PANEL WITH HONEYCOMB CORE

(71) Applicant: AIRCELLE, Gonfreville L'Orcher (FR)

(72) Inventors: Guy Bernard VAUCHEL, Harfleur (FR); Didier LERETOUR, Mannevillette (FR)

(21) Appl. No.: 14/511,939

(22) Filed: Oct. 10, 2014

Related U.S. Application Data
(63) Continuation of application No. PCT/FR2013/050775, filed on Apr. 10, 2013.

(30) Foreign Application Priority Data
Apr. 11, 2012 (FR) 12/53277

(51) Int. Cl. B32B 3/12; B29C 45/14; B29C 45/26; B29C 45/16

(52) U.S. Cl. CPC B32B 3/12; B29C 45/1671; B29C 45/1418; B29C 45/26; B29C 45/14639; B32B 2305/024; B32B 2307/102; B29L 2009/00
USPC 428/73; 264/259; 264/266; 425/110

(57) ABSTRACT

The present disclosure provides a method for manufacturing a composite sandwich panel with an alveolar core. The alveolar core exhibits a plurality of cells each delimited by at least one wall formed from at least one partition. In particular, a portion of the partition is integrated to a support skin of the composite sandwich panel during a resin molding step.

### CROSS-REFERENCE TO RELATED APPLICATIONS

This application is a continuation of International Application No. PCT/FR2013/050775, filed on Apr. 10, 2013, which claims the benefit of FR 12/53277, filed on Apr. 11, 2012. The disclosures of the above applications are incorporated herein by reference.

### FIELD

The present disclosure relates to an acoustic attenuation panel in particular for a nacelle of an aircraft engine, and to nacelle elements equipped with such a panel.

### BACKGROUND

The statements in this section merely provide background information related to the present disclosure and may not constitute prior art.

Aircrafts engines are generators of significant noise pollution and there is a high demand aiming to reduce this pollution, and this is all the more since the used turbojet engines become increasingly powerful.

The design of the nacelle surrounding a turbojet engine contributes to a large extent to the reduction of this noise pollution.

In order to further improve the acoustic performances of aircrafts, nacelles are provided with acoustic panels aiming to attenuate the noises generated by the engine as well as the vibrations of structures.

Such an acoustic panel exhibits a so-called sandwich structure comprising an acoustic resonator disposed between a first so-called inner skin and a second so-called outer skin. These skins are generally realized in composite materials and realized according to resin injection or transfer methods.

The inner skin is solid and intended to be oriented backward of the panel while the outer skin, also so-called acoustic skin, is perforated and intended to be oriented toward the source of noise.

The acoustic resonator constitutes the core of the panel and is formed of one or several alveolar structures, eventually disposed in layers and separated where appropriate by septa (multi-perforated porous skin). The alveolar structures might typically be realized from a foam-type material or preferably from so-called honeycomb structures exhibiting a set of alveolar cells, classically with hexagonal section.

In the particular case of an aeronautical application, one might more specifically use an alveolar structure exhibiting cells of relatively reduced size of about 10 mm in cross-sectional extent and realized in a material based on aluminum or fibers of the Nomex® type particularly resistant to high temperatures.

The realization of these acoustic attenuation panels is complex and expensive.

More particularly, there are known two methods for realizing such acoustic panels with a sandwich structure.

In a first solution, the alveolar structures are disposed on a pre-cured composite wall which will constitute the acoustic outer skin of the panel. This skin is most of the time pierced with multiple holes at least one of which is in correspondence with a cell of the alveolar structure.

The assembly is then covered with composite plies while still fresh, plies which will hence constitute the solid inner skin, then the whole is polymerized at heat in order to give a structural coherence to the assembly.

When several levels of alveolar structures are to be positioned, it is almost mandatory to anchor these elements on the first skin in order to stabilize the assembly before draping while still fresh to keep a good positioning of said alveolar structures and avoid the crushes in chamfer areas. The anchoring consists in performing an intermediate curing of the alveolar structures on the first skin before realizing the over-draping while still fresh.

In a second solution, the alveolar structures are housed inside polymerized composite elements, a first element forming a cavity inside which the alveolar structure or structures are installed, the other element, closing the whole for example by bonding, on a peripheral return of the first element. The first element will generally constitute the solid inner skin, while the second element inserted by bonding will constitute the acoustic outer skin.

Thus, it is understood that the realization of such an acoustic panel necessitates, whatever the employed method is, numerous steps of curing and polymerization of the sandwich structure.

It also necessitates a particular attention in order to provide the continuity of contact between bonding zones and the surface of the honeycomb with the acoustic skin.

Furthermore, the diverse operations of machining and assembling of the panels (therebetween or on the nacelle) frequently lead to the acoustic neutralization of several cells, leading therefore to a decrease of the acoustic absorption performances of the panel.

It should also be noted that these panels may be intended to be installed in areas with high mechanical or thermal constraints (hot area of a turbojet engine for example), and hence must be realized in suitable materials.

There is hence a need for a solution allowing the realization of such acoustic panels with an alveolar core and reducing the precedingly mentioned drawbacks.

### SUMMARY

The present disclosure provides a method for manufacturing a composite sandwich panel with an alveolar core exhibiting a plurality of cells each delimited by at least one wall formed from at least one partition, characterized in that at least one portion of said partitions is integrated to a support skin of the sandwich panel during a resin molding step.

Thus, by integrating at least partially the partitions constituting the alveolar walls to a support skin, the integrity of the acoustic panel is reinforced and the setting up of the alveolar core is facilitated and more precise.

According to a first form, the partition is integrated to the support skin at least at one of its ends. We might to this end provide marks for positioning, retaining or centering in particular, in a mold of the support skin.

Such a form allows using partitions made of light materials, and/or flexible, which is interesting in particular when their structural strength is less problematic.

According to a second form, at least one partition is at least partially realized by resin molding simultaneously with the step of molding the support skin by said resin.

Such a form allows an improved integration of the partitions to the alveolar walls and they might thus be realized from the same material as the skin of the panel.

The partitions might in particular be realized from resin alone or filled or the method might comprise a step of setting up composite plies and/or preforms in at least one molding space of the partition.

According to one particular form, at least one partition is inserted before integration in the resin.

Of course, based on the structural strength needs of the partitions, we might realize some partitions directly in a composite material, while other partitions might be inserted and integrated to the resin of the support skin.

In a complementary manner, the method comprises a step of installing at least one septum inside at least one cell.

In another form, the support skin is a solid inner skin of the sandwich panel.

The present disclosure also relates to a mold for the implementation of the method according to the present disclosure and the realization of a composite sandwich panel comprising at least one main shell substantially defining, with a corresponding closing cover, the outer general volume of the panel to be realized, characterized in that said mold comprises at least one secondary mold intended to be placed inside the main shell during molding and providing with the main shell a molding space of a support skin, characterized in that said secondary mold exhibits marks of cells to be realized, said marks of cells being spaced by a distance substantially corresponding to the thickness of partitions defining walls of said cells to be realized, so as to provide at least one space for the realization of said partitions.

According to a first form, the realization space of the partitions is a molding space of said walls, in fluid communication with the molding space of the support skin. Thus, this allows realizing the partitions with the resin injected during molding of the support skin.

In another form, the secondary mold is fastened to the closing cover of the mold.

Advantageously, the main shell defines at least partially at least one portion of a peripheral return of the panel. This peripheral return might in particular serve for the fixation, for example by bonding, of the acoustic outer skin closing the panel.

Advantageously, at least one portion of the marks of cells exhibits at least one draining mark each intended to receive a draining strip.

According to one particular form, the secondary mold exhibits marks of cells of different depths.

According to another form, the shell exhibits at least one retaining and/or centering mark capable of receiving, where appropriate, at least one inserted partition.

The present disclosure further relates to a sandwich panel with an alveolar core which may be obtained by the method according to the present disclosure and where appropriate by means of a mold according to the present disclosure, said panel comprising at least one composite support skin and at least one core exhibiting a plurality of cells each delimited by at least one wall formed from at least one partition, characterized in that at least one portion of said partitions is integrated to the support skin by resin molding.

According to a first form, at least one portion of the partitions is at least partially realized from the resin of the composite support skin.

According to a second form, at least one portion of the partitions is inserted and integrated to the resin of the composite support skin

Advantageously, at least one portion of the cells is of different depths.

The support skin is a solid composite skin as another form according to the present disclosure.

In still another form, the core is covered with at least one pierced acoustic composite skin.

Advantageously, at least one portion of the cells is divided by at least one septum.

According to another form; at least one portion of the marks of cells is inserted or molded in the inner mark of the support skin. The secondary mold may in particular be integral with the support skin.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 to 11 show a first form of a method according to the present disclosure;

FIGS. 12 to 14 show different forms of implementations;

FIGS. 15 to 18 illustrate a second form of the present disclosure; and

FIGS. 19 to 24 illustrate a third form with different implementations.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As precedingly explained, a composite sandwich panel 1 comprises an alveolar core 2 disposed between an inner skin 3 and an outer skin (not represented).

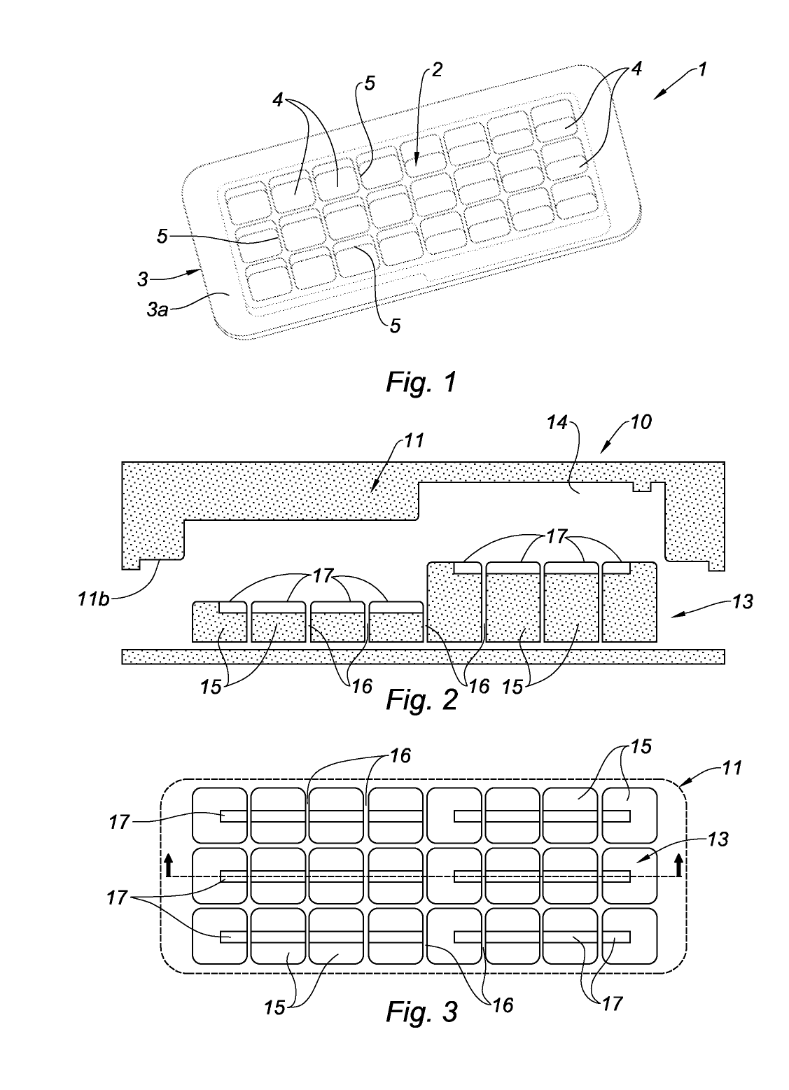

Such a panel 1, still not covered with its outer skin is represented in FIG. 1.

The inner skin 3 defines a volume inside which is located the alveolar core 2 exhibiting a plurality of cells 4 each delimited by at least one wall formed from at least one partition 5.

It will be noted that the inner skin 3 exhibits a peripheral rim 3a, rim intended to the fixation, for example by bonding, of the outer skin, in particular a pierced acoustic outer skin.

Such a composite sandwich panel may be realized by the method of the present disclosure in which at least one portion of said partitions is integrated to a support skin of the sandwich panel during a resin molding step

To do so, we might use a mold 10 as represented in FIGS. 2 and 3.

Such a mold 10 comprises a main shell 11 substantially defining, with a corresponding closing cover 12, the outer general volume of the panel 1 to be realized.

It will be noted that the main shell 11 exhibits a peripheral inner surface 11b defining the peripheral return 3b of the support skin 3 of the panel 1.

The mold 10 further comprises a secondary mold 13 intended to be placed inside the main shell 11 during molding and providing with the main shell a molding space 14 of the support skin 3 of the panel 1.

This secondary mold 13 also exhibits marks 15 of the cells 4 to be realized, said marks 15 of cells 4 being spaced by a distance substantially corresponding to the thickness of partitions 5 defining walls of said cells to be realized, and thus providing a space 16 between the marks 15 of cells 4 for the realization of said partitions.

The realization space 16 of the partitions 5 is in fluid communication with the molding space 14 of the support skin 3 of the panel 1. Thus, during the injection of resin, this latter will propagate in the entire mold and will realize said partitions 5 directly with the support skin 3.

In a complementary advantageous manner, at least one portion of the marks 15 of cells 4 exhibits at least one draining mark 17 each intended to receive a draining strip 18.

These draining marks 17 may be through going or extend only over a portion of the cell 4 mark 15. They thus define a draining passage through the cells 4 intended to the evacuation of water that is likely to accumulate in said cells 4.

Water will be drained out of the panel via a port 17b provided in a cell 4 proximate to an end of a draining mark 17. The port will be obtained by providing a corresponding protuberance 17c in the shell crossing the molding space 14 of the support skin 3 to come into contact against the mark 16 of the cell 4 at which this port 17b must be provided. This protuberance thus occupies a place which will not be filled by resin, a place which will form a port 17b during demolding.

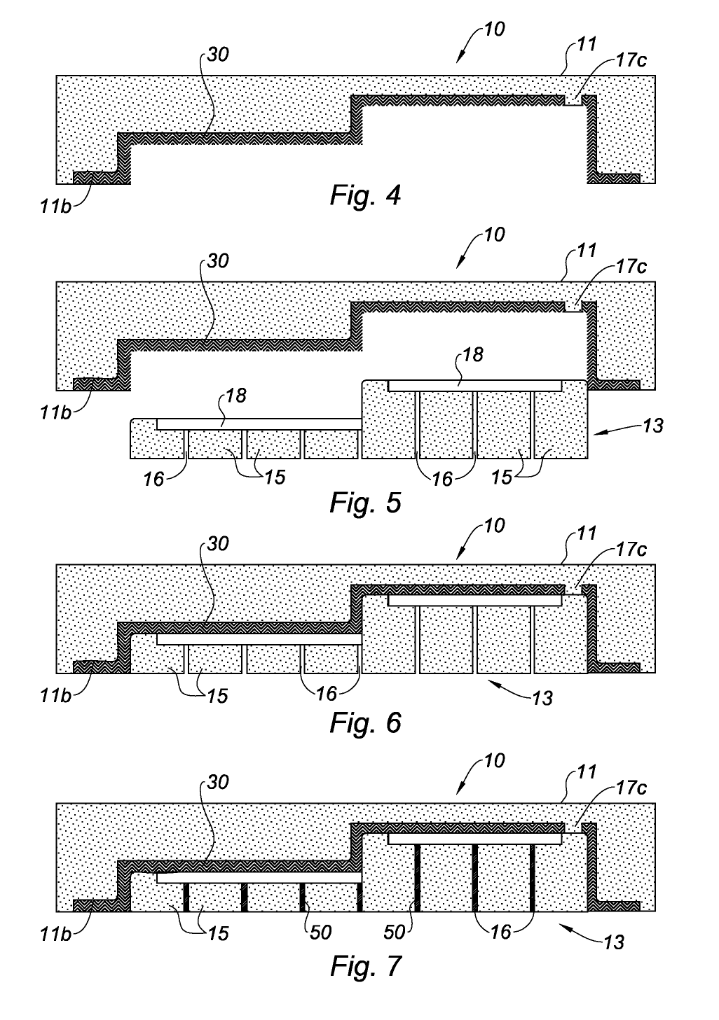

FIGS. 4 to 11 illustrate the different steps of implementing the method for manufacturing the panel 1 with the help of the mold 10.

In a first step (FIG. 4), a preform or a set of plies 30 of the support skin 3 is disposed inside the shell 11 of the mold 10 at the molding space 14 of said support skin.

As it is visible in FIG. 5, the secondary mold 13 is installed with its draining strips 18 inside the shell 11 and covers (FIG. 6) the molding space 14 and the plies 30 of the support skin 3 to be realized.

We then proceed (FIG. 7) to the setting up of the preforms or plies 50 intended to form the partitions 5.

It is of course possible not to install plies 50 and realize the partitions 5 in resin alone, eventually in resin filled, or reinforced with long fibers so-called UD.

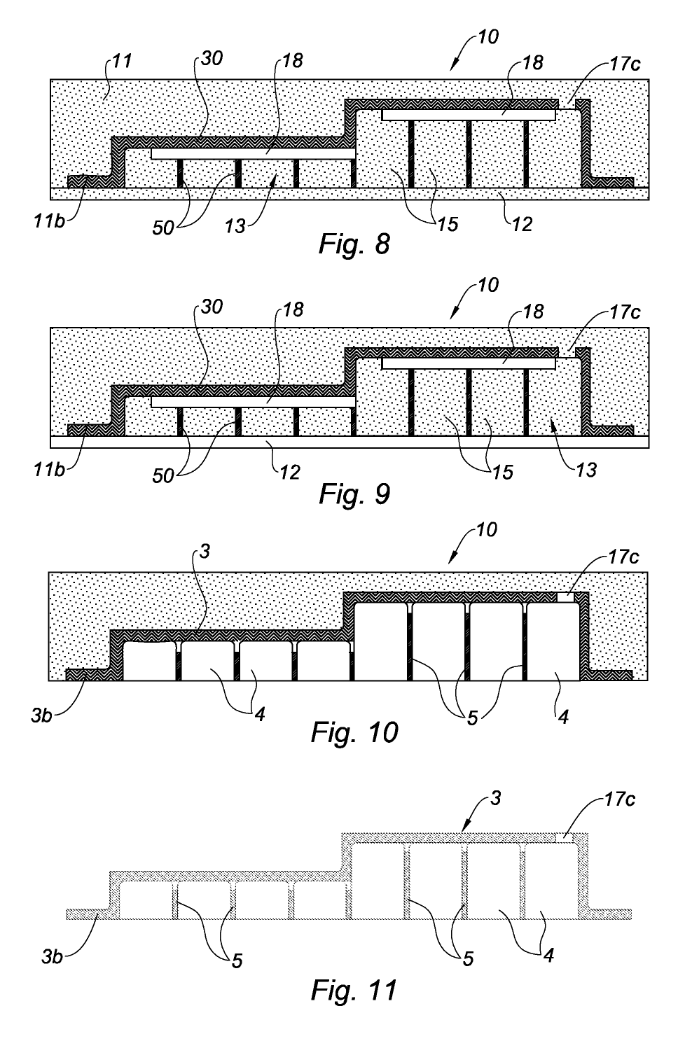

We may then close the mold 10 by its cover 12 (FIG. 8) and proceed to the injection of the resin (FIG. 9).

Once the resin is polymerized, the mold 10 is open, and the secondary mold 13 (hence the marks 14 of cells 4) is removed. The draining strips 18 are also extracted or eliminated.

The molded shape is extracted from the shell 11 (FIG. 11) and constitutes the basis of the alveolar panel 1 before setting up the outer skin (not visible), acoustic in the case of an acoustic panel, by bonding of said outer skin on the peripheral rim 3a if the support skin 3.

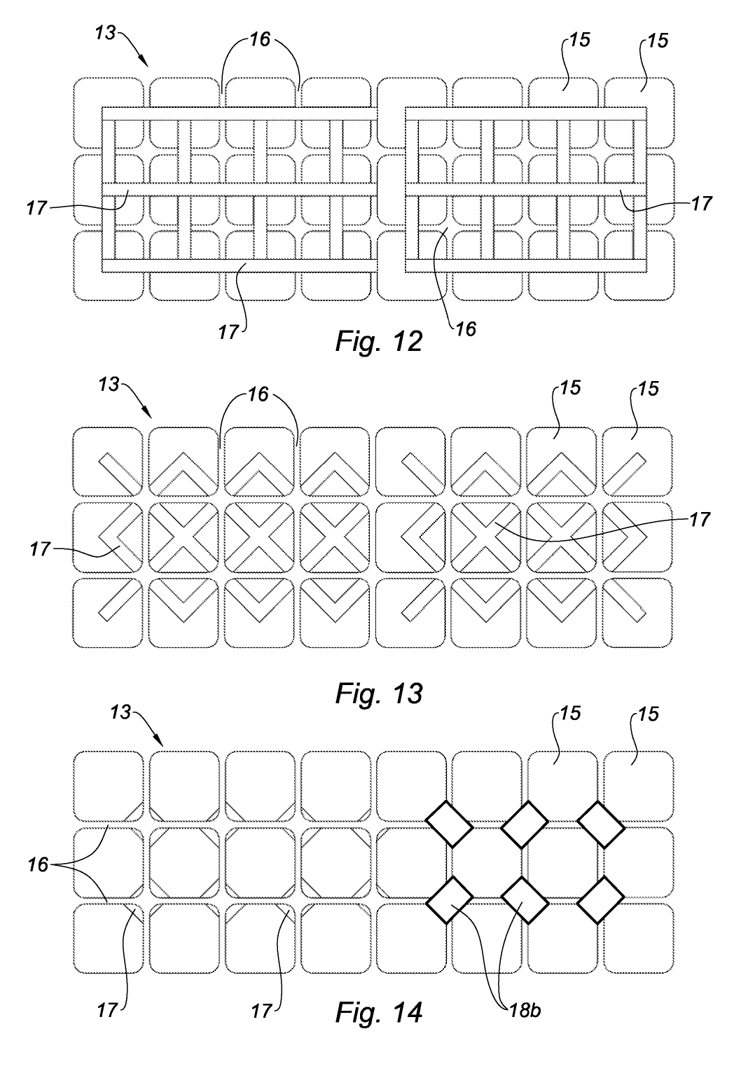

FIGS. 12 to 14 show different possibilities for disposing the draining marks 17 and the draining strips 18.

The layout of FIG. 3 would allow obtaining a disposal by line of cells 4. It was hence recommended to provide as many draining ports 17b as lines of cells.

FIG. 12 shows a cross layout allowing obtaining a common disposal which needs only one single draining port 17b.

A reduced number of draining ports 17b is a parameter when seeking to have the smallest possible leakage surface between the inner and the outer of the panel 1, in particular when there are different pressure levels on either side of the respective part, which is frequently the case in turbojet engine nacelles.

FIG. 13 shows cross-disposed draining marks, allowing a cross draining in the cells 4 nodes.

FIG. 14 shows draining marks 17 located at cells 4 nodes and intended to receive draining strips in the form of cores 18b.

As another form, it is possible, for some panels needing lesser structural strength, to realize the molding with filled resin without inner plies 30 reinforcement. The resulting advantage is a part directly injected after setting up the secondary mold 13 with the draining strips 17 without having to dispose the shell, then the partitions 5, reinforcing plies 30. This allows gains in production cost.

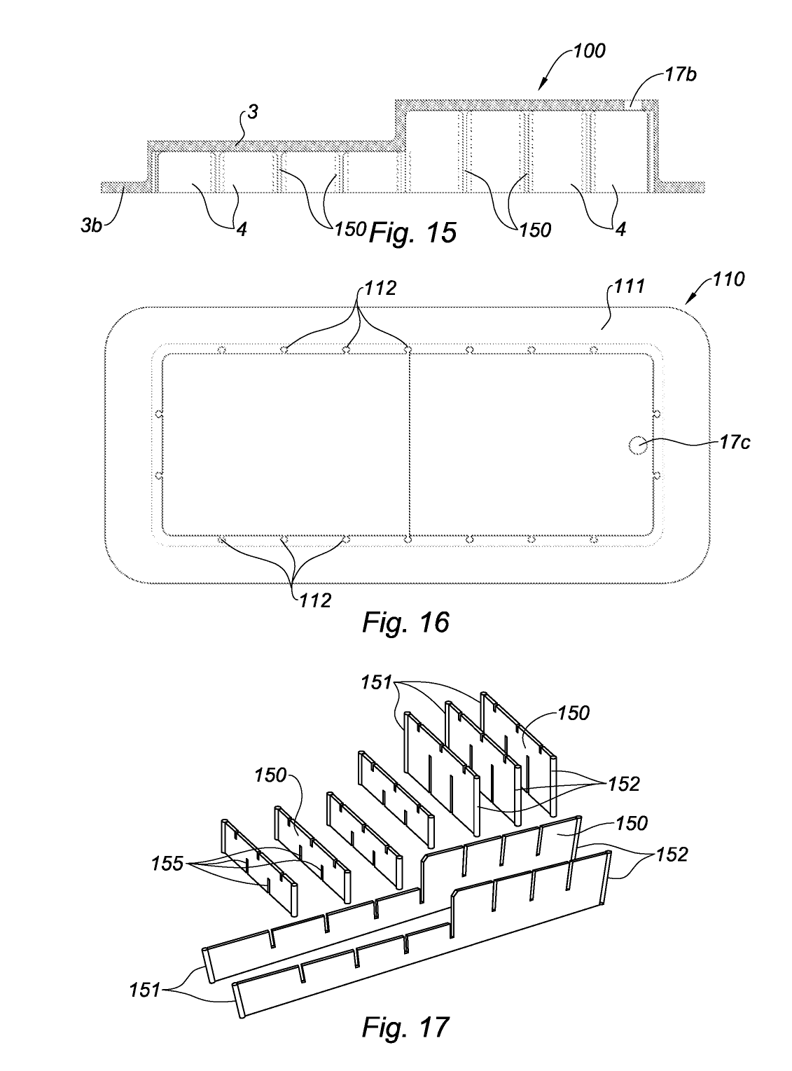

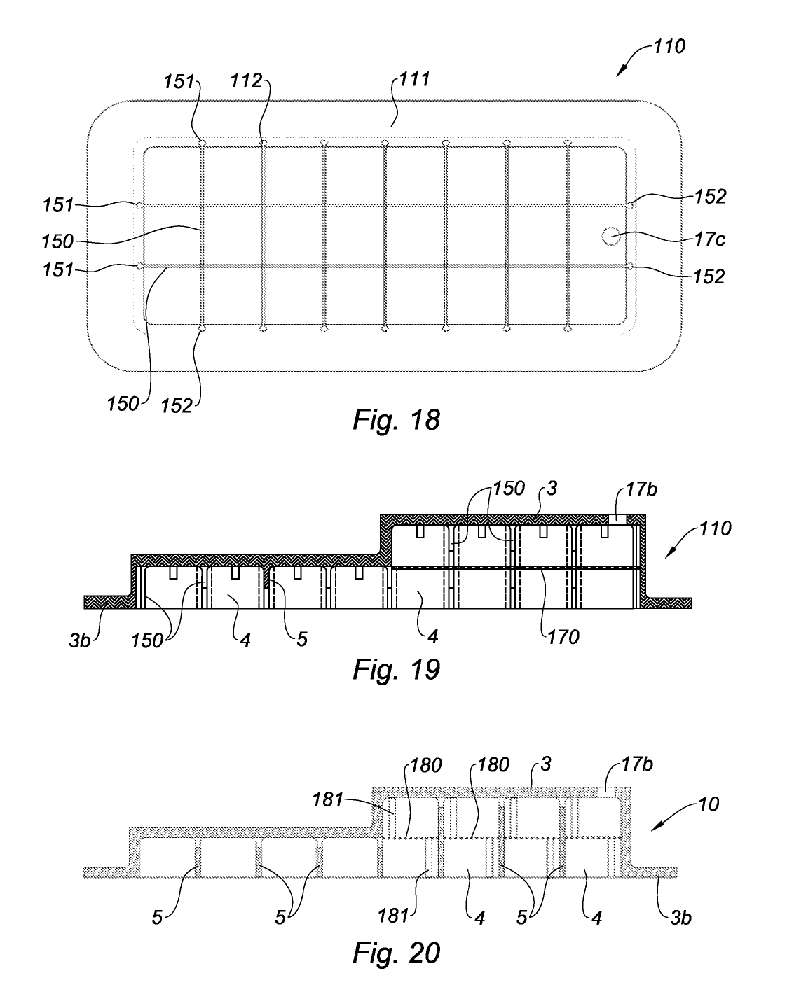

According to another form, more particularly represented in FIGS. 15 to 19, a panel 100 comprises partitions 150 inserted inside the support skin 3 and integrated to the latter by its ends 151, 152.

To do so, a mold 110 comprises a shell 111 exhibiting on a peripheral inner face a set of retaining marks 112 each intended to receive an end 151, 152 of a partition 150.

According to another form of the present disclosure, it might be centering marks, exhibiting for example a V-section, not having a retaining function.

The partitions 150 might be realized in the form of nestable walls. The partitions 150 might also directly comprise notches 155 intended to allow draining the cells 4.

The heights of the partitions 150 are adapted to the depth of the shell 111. A removal of a partition 150 may be considered in view of the mass and the potential pinching of each element. A mastered overlapping mounting may also be considered based on the compaction flexibility of the partitions assembly.

Such a form may be associated with integrated walls realized from the resin of the support skin 3 according to the precedingly described (FIG. 19) form, in particular if it appears necessary to have a reinforcement of the structure by this means.

As another form, the inner of the support skin 3 may receive a compact set of inserted marks of cells, centered only in the mark by the peripheral partitions.

FIGS. 19 to 24 illustrate complementary forms to equip at least one portion of the cells 4 with at least one acoustic septum.

In fact, as it is visible in the preceding figures, the panels 10, 110 have cells of two different depths, and the deeper cells are intended to be equipped with a septum.

Of course, the less deep cells may also be equipped with a septum.

A first form represented in FIG. 19 consists, from the inserted partitions 150 form, in depositing a complete or partial septum 170 between two partitions 150 stages. The septum 170 is of a type known to one skilled in the art and advantageously comprises two to three of micro-perforated glass plies.

The other forms represented in FIGS. 20 to 24 are independent from the form of the panel (partitions inserted or realized in the resin).

These alternatives use individual septa in the form of pellets 180 disposed inside a cell 4.

The pellets may be realized in any type of material suitable to the utilization of the final part. They might in particular be metallic or plastic, in a material suitable to the utilization temperature of the panel. They may also be machined, stamped or molded.

The pellets might be planar or self-stiffened (in surface or on their edges) and might be used in a position that is not parallel to the acoustic skin.

Each pellet 180 is mounted on positioning tabs 181 allowing maintaining it at the desired distance relative to the support skin 3 and to the acoustic skin of the panel.

In FIG. 20, only the deepest cells are divided by a septum pellet 180. The positioning tabs 181 are furthermore defined so that the pellets 180 of the different cells are substantially aligned and divide the cells in the same proportions (substantially to half).

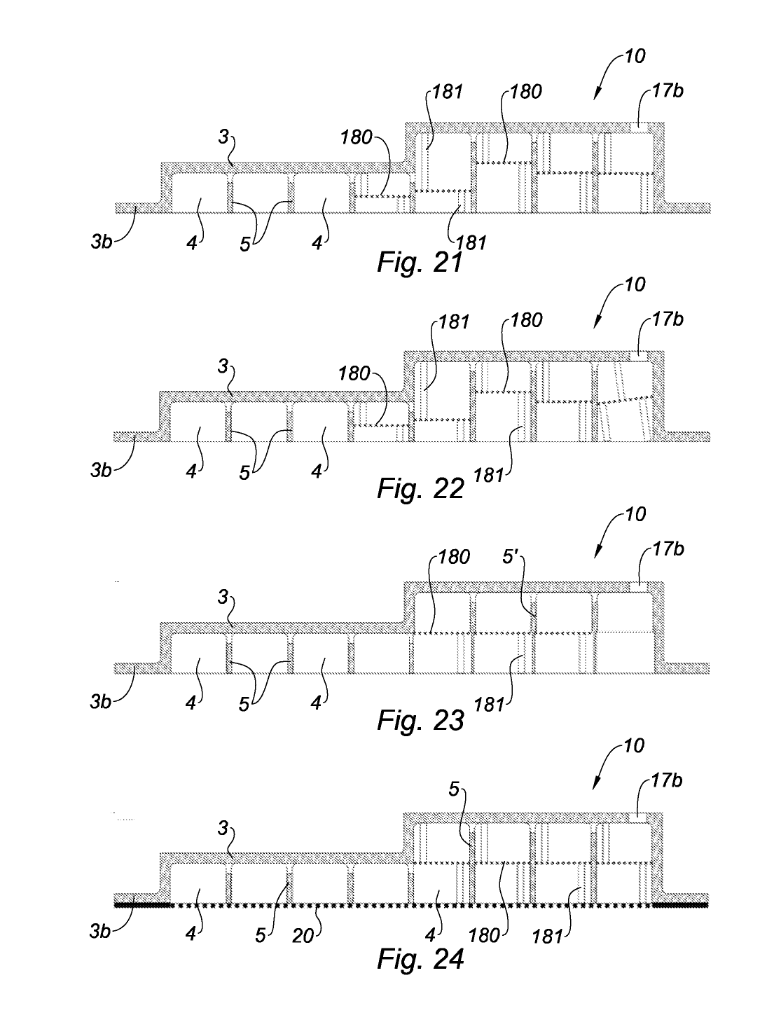

In FIG. 21, the treatment is distributed. All the pellets 180 are not fixed at the same depth and are also installed in less deep cells 4.

In FIG. 22, a pellet 180 is tilted.

FIG. 23 shows a form in which the partitions 5 are realized by resin molding so as to exhibit heels. More precisely, the partitions 5 exhibit a slightly less large basis than a more tapered top portion. It follows the formation of side heels on which a septum pellet 180 may bear. This allows the removal of a portion of the positioning tabs 181.

FIG. 24 shows an example of a finished panel 10, comprising an acoustic skin inserted on the support skin 3 so as to close the panel and cover the cells 4.

Although the present disclosure has been described with a particular form, it is obvious that it is in no way limited thereto and it comprises all technical equivalents of the described means as well as their combinations if they are within the scope of the present disclosure.

What is claimed is:

1. A method for manufacturing a composite sandwich panel with an alveolar core exhibiting a plurality of cells each delimited by at least one wall formed from at least one partition, wherein at least one portion of said partition is integrated to a support skin of the composite sandwich panel during a resin molding step.

2. The method according to claim 1, wherein the partition is integrated to the support skin at least at one of its ends.

3. The method according to claim 2, wherein said at least one partition is inserted before the integration in the resin.

4. The method according to claim 1, wherein said at least one partition is at least partially realized by resin molding simultaneously with a step of molding the support skin by said resin.

5. The method according to claim 4, further comprising a step of setting up composite plies and/or preforms in at least one molding space of said at least one partition.

6. The method according to claim 1, further comprising a step of installing at least one septum inside at least one of the plurality of cells.

7. The method according to claim 1, wherein the support skin is a solid inner skin of the composite sandwich panel.

8. A mold for realizing a composite sandwich panel comprising at least one main shell substantially defining, with a corresponding closing cover, an outer general volume of the composite sandwich panel to be realized,
wherein said mold comprises at least one secondary mold to be placed inside said at least one main shell during molding, providing the main shell with a molding space of a support skin, and
wherein said at least one secondary mold exhibits marks of cells to be realized, said marks of cells being spaced by a distance corresponding substantially to a thickness of partitions defining walls of said cells to be realized, so as to provide at least one space for realization of said partitions.

9. The mold according to claim 8, wherein said at least one space of the partitions is a molding space of said walls, in fluid communication with the molding space of the support skin.

10. The mold according to claim 8, wherein said at least one secondary mold is fastened to said corresponding closing cover of the mold.

11. The mold according to claim 8, wherein at least one portion of the marks of cells is inserted or molded in an inner mark of the support skin.

12. The mold according to claim 8, wherein said at least one main shell defines at least partially at least one portion of a peripheral return of the composite sandwich panel.

13. The mold according to claim 8, wherein at least one portion of the marks of cells exhibits at least one draining mark each to receive a draining strip.

14. The mold according to claim 8, wherein said at least one secondary mold exhibits said marks of cells with different depths.

15. The mold according to claim 8, wherein said at least one main shell exhibits at least one of retaining and centering mark configured to receive at least one inserted partition where appropriate.

16. A sandwich panel with an alveolar core comprising:
at least one composite support skin; and
at least one core exhibiting a plurality of cells each delimited by at least one wall formed from at least one partition,
wherein at least one portion of said at least one partition is integrated with said at least one composite support skin by resin molding.

17. The sandwich panel according to claim 16, wherein said at least one portion of said at least one partition is at least partially realized from a resin of said at least one composite support skin.

18. The sandwich panel according to claim 16, wherein said at least one portion of said at least one partition is inserted and integrated to a resin of said at least one composite support skin.

19. The sandwich panel according to claim 16, wherein the plurality of cells are of different depths.

20. The sandwich panel according to claim 16, wherein said at least one composite support skin is a solid composite skin.

21. The sandwich panel according to claim 16, wherein said at least one core is covered with at least one pierced acoustic composite skin.

22. The sandwich panel according to claim 16, wherein at least one portion of the plurality of cells is divided by at least one septum.

23. The sandwich panel according to claim 22, wherein said at least one septum is realized in a form of one individual pellet.

24. The sandwich panel according to claim 22, further comprising several septum pellets disposed inside the plurality of cells at different levels.

25. The sandwich panel according to claim 22, wherein said at least one septum comprises at least one septum pellet tilted relative to a bottom surface of corresponding cell of the plurality of cells.
